(19) United States
(12) Patent Application Publication
(10) Pub. No.: US 2018/0260317 A1
(43) Pub. Date: Sep. 13, 2018

(54) METHOD FOR MANAGING THE COPYING AND STORING OF DATA IN GARBAGE COLLECTION, MEMORY STORAGE DEVICE AND MEMORY CONTROL CIRCUIT UNIT USING THE SAME

(71) Applicant: PHISON ELECTRONICS CORP., Miaoli (TW)

(72) Inventor: Chien-Hua Chu, Hsinchu County (TW)

(73) Assignee: PHISON ELECTRONICS CORP., Miaoli (TW)

(21) Appl. No.: 15/973,548

(22) Filed: May 8, 2018

Related U.S. Application Data
(63) Continuation of application No. 14/280,673, filed on May 19, 2014, now abandoned.

(30) Foreign Application Priority Data
Mar. 21, 2014 (TW) 103110716

(51) Int. Cl. G06F 12/00

(52) U.S. Cl. CPC G06F 12/00

(57) ABSTRACT

A memory management method, a memory storage device and a memory control circuit unit are provided. The method includes: receiving a first write command from a host system and writing a first data indicated by the first write command to a physical erasing unit which is currently served as a receiving physical erasing unit; and copying valid data from a first physical erasing unit and writing the valid data to a physical erasing unit which is currently served as a recycling physical erasing unit in a garbage collection operation, where the physical erasing unit currently served as the receiving physical erasing unit and the physical erasing unit currently served as the recycling physical erasing unit are two physical erasing units independent from each other.

### CROSS-REFERENCE TO RELATED APPLICATION

This application is a continuation application of and claims the priority benefit of U.S. application Ser. No. 14/280,673, filed on May 19, 2014, now pending, which claims the priority benefit of Taiwan application serial no. 103110716, filed on Mar. 21, 2014. The entirety of each of the above-mentioned patent applications is hereby incorporated by reference herein and made a part of this specification.

### BACKGROUND

### Technology Field

The invention relates to a memory management mechanism, and more particularly, to a memory management method, a memory storage device and a memory control circuit unit for a rewritable non-volatile memory module.

### Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., flash memory) ideal to be built in the portable multi-media devices as cited above.

Generally, after the rewritable non-volatile memory module is used for a period of time, the rewritable non-volatile memory module may automatically execute a garbage collection procedure to release memory spaces occupied by invalid data. However, the garbage collection procedure may result in confusion between old valid data being collected and newly written data, so as lower a data writing efficiency of the rewritable non-volatile memory module in executing a sequential write afterward.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The invention is directed to a memory management method, a memory storage device and memory control circuit unit, capable of effectively solving the problem in which the data writing efficiency of the rewritable non-volatile memory module is lowered after being used for a long period of time.

The invention provides a memory management method for a rewritable non-volatile memory module having a plurality of physical erasing units, and the memory management method comprising: receiving a first write command from a host system and writing a first data indicated by the first write command to a physical erasing unit which is currently served as a receiving physical erasing unit among the physical erasing units; and copying valid data from a first physical erasing unit among the physical erasing units and writing the valid data to a physical erasing unit which is currently served as a recycling physical erasing unit among the physical erasing units in a garbage collection operation, wherein the physical erasing unit currently served as the receiving physical erasing unit and the physical erasing unit currently served as the recycling physical erasing unit are two physical erasing units independent from each other.

The invention also provides a memory storage device which comprises a connection interface unit, a rewritable non-volatile memory module and a memory control circuit unit. The connection interface unit is configured to couple to a host system. The rewritable non-volatile memory module comprises a plurality of physical erasing units. The memory control circuit unit is coupled to the connection interface unit and the rewritable non-volatile memory module, wherein the memory control circuit unit is configured to receive a first write command from the host system and issue a first write command sequence instructing to write a first data indicated by the first write command to a physical erasing unit which is currently served as a receiving physical erasing unit among the physical erasing units, wherein the memory control circuit unit is further configured to copy valid data from a first physical erasing unit among the physical erasing units and issue a second write command sequence instructing to writing the valid data to a physical erasing unit which is currently served as a recycling physical erasing unit among the physical erasing units in a garbage collection operation, wherein the physical erasing unit currently served as the receiving physical erasing unit and the physical erasing unit currently served as the recycling physical erasing unit are two physical erasing units independent from each other.

The invention also provides a memory control circuit unit configured to control a rewritable non-volatile memory module. The rewritable non-volatile memory module comprises a plurality of physical erasing units, and the memory control circuit unit comprises a host interface, a memory interface and a memory management circuit. The host interface is configured to couple to a host system. The memory interface is configured to couple to the rewritable non-volatile memory module. The memory management circuit is coupled to the host interface and the memory interface, wherein the memory management circuit is configured to receive a first write command from the host system and issue a first write command sequence instructing to write a first data indicated by the first write command to a physical erasing unit which is currently served as a receiving physical erasing unit among the physical erasing units, wherein the memory management circuit is further configured to copy valid data from a first physical erasing unit among the physical erasing units and issue a second write command sequence instructing to writing the valid data to a physical erasing unit which is currently served as a recycling physical erasing unit among the physical erasing units in a garbage collection operation, wherein the physical erasing unit currently served as the receiving physical erasing unit and the physical erasing unit currently served as the recycling physical erasing unit are two physical erasing units independent from each other.

Based on above, the invention is capable of writing the data from the host system into the receiving physical erasing unit, and writing the valid data collected from part of physical erasing units in the rewritable non-volatile memory module into the recycling physical erasing unit. Accordingly, the old valid data in the rewritable non-volatile memory module and the new data will not be stored in the same physical erasing unit, so as to effectively solve the problem in which the data writing efficiency of the rewritable non-volatile memory module is lowered after being used for a long period of time.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a host system and a memory storage device according to an exemplary embodiment of the invention.

FIG. 1B is a schematic diagram of a computer, an input/output device, and a memory storage device according to an exemplary embodiment of the invention.

FIG. 1C is a schematic diagram of a host system and a memory storage device according to an exemplary embodiment of the invention.

FIG. 2 is a schematic block diagram illustrating the memory storage device depicted in FIG. 1A.

FIG. 3 is a schematic block diagram illustrating a memory control circuit unit according to an exemplary embodiment of the invention.

FIG. 4 is a schematic diagram illustrating management of a rewritable non-volatile memory module according to an exemplary embodiment of the invention.

FIG. 5A and FIG. 5B are schematic diagrams illustrating management of a memory storage device according to an exemplary embodiment of the invention.

FIG. 6 is a schematic diagram illustrating management of a rewritable non-volatile memory module according to an exemplary embodiment of the invention.

FIG. 7 is a flowchart illustrating a memory management method according to an exemplary embodiment of the invention.

FIG. 8 is a flowchart illustrating a memory management method according to an exemplary embodiment of the invention.

FIG. 9 is a flowchart illustrating a memory management method according to an exemplary embodiment of the invention.

FIG. 10 is a flowchart illustrating a memory management method according to an exemplary embodiment of the invention.

FIG. 11 is a flowchart illustrating a memory management method according to an exemplary embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A,B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a memory storage device (also known as a memory storage system) includes a rewritable non-volatile memory module and a controller (also known as a control circuit). The memory storage device is usually configured together with a host system so that the host system may write data into or read data from the memory storage device.

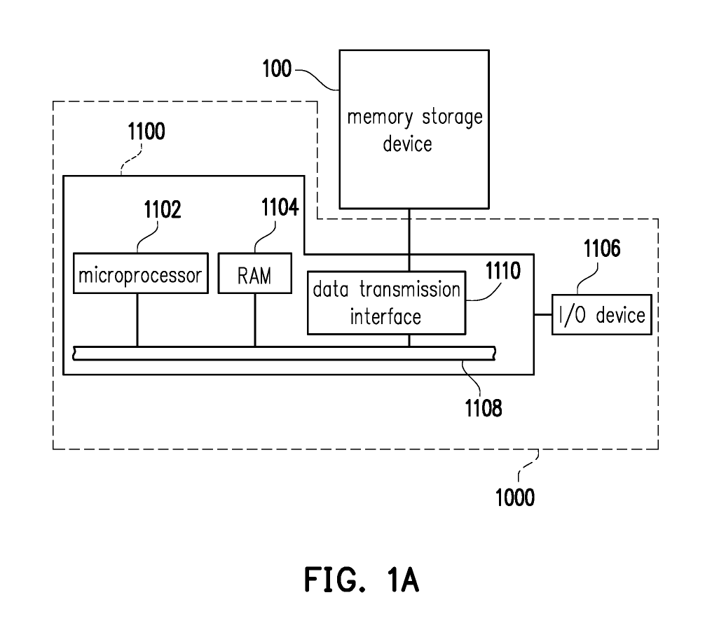

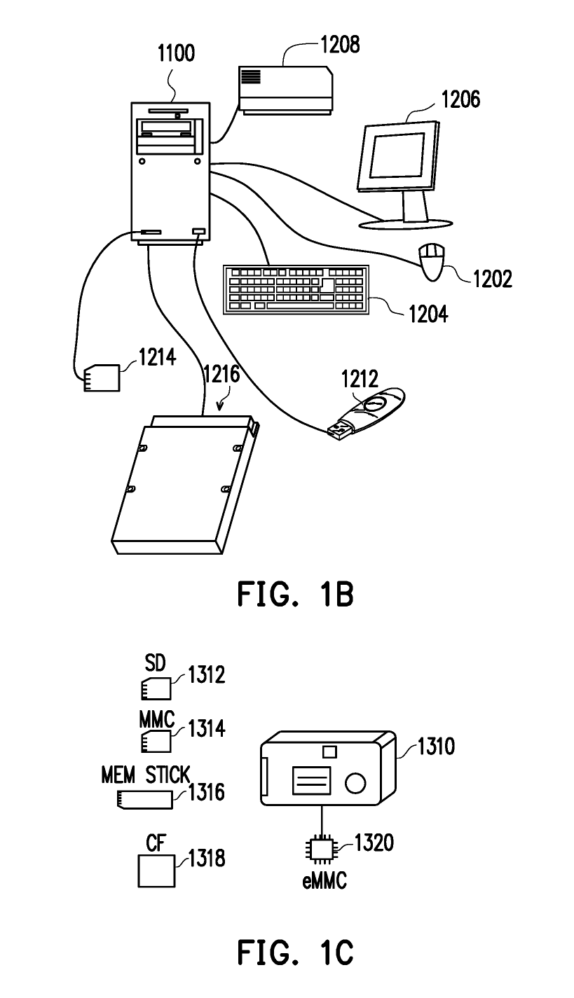

FIG. 1A illustrates a host system and a memory storage device according to an exemplary embodiment of the invention. FIG. 1B is a schematic diagram of a computer, an input/output device, and a memory storage device according to an exemplary embodiment of the invention. FIG. 1C is a schematic diagram of a host system and a memory storage device according to an exemplary embodiment of the invention.

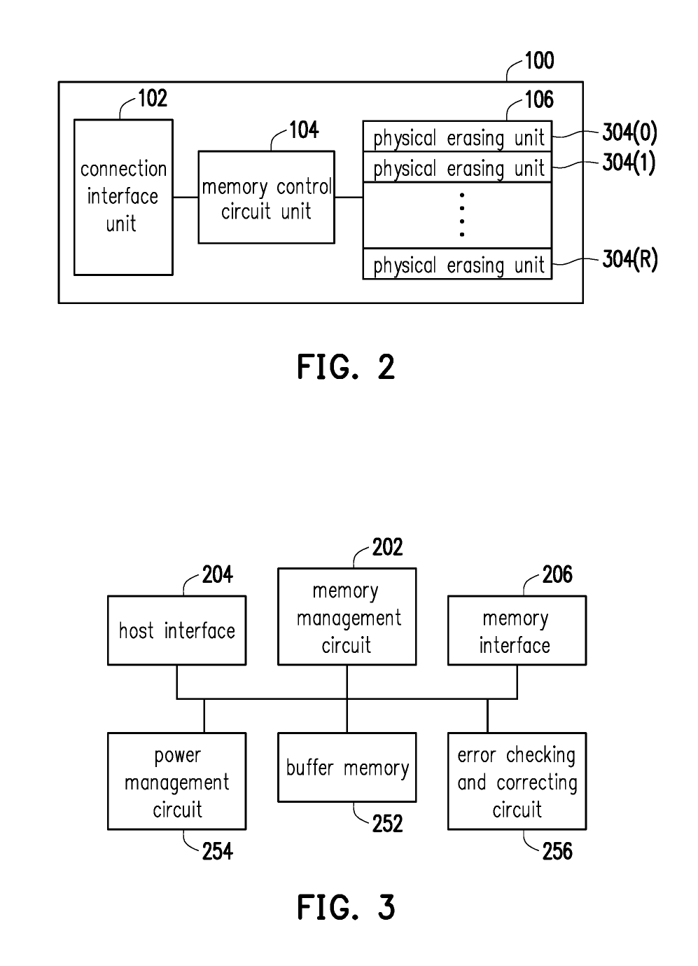

Referring to FIG. 1A, a host system 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206 and a printer 1208 as shown in FIG. 1B. It should be understood that the devices illustrated in FIG. 2 are not intended to limit the I/O device 1106, and the I/O device 1106 may further include other devices.

In the present embodiment of the invention, the memory storage device 100 is coupled to other devices of the host system 1000 through the data transmission interface 1110. By using the microprocessor 1102, the random access memory 1104 and the Input/Output (I/O) device 1106, data may be written into the memory storage device 100 or may be read from the memory storage device 100. For example, the memory storage device 100 may be a rewritable non-volatile memory storage device such as a flash drive 1212, a memory card 1214, or a solid state drive (SSD) 1216 as shown in FIG. 2.

Generally, the host system 1000 may substantially be any system capable of storing data with the memory storage device 100. Although the host system 1000 is described as a computer system in the present exemplary embodiment, in another exemplary embodiment of the invention, the host system 1000 may be a digital camera, a video camera, a telecommunication device, an audio player, or a video player. For example, if the host system is a digital camera (video camera) 1310, the rewritable non-volatile memory storage device may be a SD card 1312, a MMC card 1314, a memory stick 1316, a CF card 1318 or an embedded storage device 1320 (as shown in FIG. 1C). The embedded storage device 1320 includes an embedded MMC (eMMC). It should be mentioned that the eMMC is directly coupled to a substrate of the host system.

FIG. 2 is a schematic block diagram illustrating the memory storage device depicted in FIG. 1A.

Referring to FIG. 2, the memory storage device 100 includes a connection interface unit 102, a memory control circuit unit 104 and a rewritable non-volatile memory storage module 106.

In the present exemplary embodiment, the connection interface unit 102 is compatible with a serial advanced technology attachment (SATA) standard. However, the invention is not limited thereto, and the connection interface unit 102 may also be compatible to Parallel Advanced Technology Attachment (PATA) standard, Institute of Electrical and Electronic Engineers (IEEE) 1394 standard, Peripheral Component Interconnect (PCI) Express interface standard, Universal Serial Bus (USB) standard, Ultra High Speed-I (UHS-I) interface standard, Ultra High Speed-II (UHS-II) interface standard, Secure Digital (SD) interface standard, Memory Stick (MS) interface standard, Multi Media Card (MMC) interface standard, Compact Flash (CF) interface standard, Integrated Device Electronics (IDE) interface standard or other suitable standards. In the present exemplary embodiment, the connection interface unit and the memory control circuit unit may be packaged into one chip, or distributed outside of a chip containing the memory control circuit unit.

The memory control circuit unit 104 is configured to execute a plurality of logic gates or control commands which are implemented in a hardware form or in a firmware form, so as to perform operations of writing, reading or erasing data in the rewritable non-volatile memory storage module 106 according to the commands of the host system 1000.

The rewritable non-volatile memory storage module 106 is coupled to the memory control circuit unit 104 and configured to store data written from the host system 1000. The rewritable non-volatile memory storage module 106 has multiple physical erasing units 304(0) to 304(R). For example, the physical erasing units 304(0) to 304(R) may belong to the same memory die or belong to different memory dies. Each physical erasing unit has a plurality of physical programming units, and the physical programming units of the same physical erasing unit may be written separately and erased simultaneously. For example, each physical erasing unit is composed by 128 physical programming units. Nevertheless, it should be understood that the invention is not limited thereto. Each physical erasing unit is composed by 64 physical programming units, 256 physical programming units or any amount of the physical programming units.

More specifically, each of the physical programming units includes a plurality of word lines and a plurality of bit lines, and a memory cell is disposed at an intersection of each of the word lines and each of the data lines. Each memory cell can store one or more bits. All of the memory cells in the same physical erasing unit are erased together. In the present exemplary embodiment, the physical erasing unit is a minimum unit for erasing. Namely, each physical erasing unit contains the least number of memory cells to be erased together. For instance, the physical erasing unit is a physical block. Furthermore, the memory cells on the same word line can be grouped into one or more of the physical programming units. In case each of the memory cells may store two or more bits, the physical programming units on the same word line may be classified into a lower physical programming unit and an upper physical programming unit. Generally, a writing speed of the lower physical programming unit is faster than a writing speed of the upper physical programming unit. In the present exemplary embodiment, the physical programming unit is a minimum unit for programming. That is, the physical programming unit is the minimum unit for writing data. For example, the physical programming unit is a physical page or a physical sector. In case the physical programming unit is the physical page, each physical programming unit usually includes a data bit area and a redundancy bit area. The data bit area has multiple physical sectors configured to store user data, and the redundant bit area is configured to store system data (e.g., an error correcting code). In the present exemplary embodiment, each of the data bit areas contains 32 physical sectors, and a size of each physical sector is 512-byte (B). However, in other exemplary embodiments, the data bit area may also include 8, 16, or more or less of the physical sectors, and amount and sizes of the physical sectors are not limited in the invention.

In the present exemplary embodiment, a rewritable non-volatile memory module 106 is a Multi Level Cell (MLC) NAND flash memory module which stores at least 2 bits in one cell. The rewritable non-volatile memory module 106 may also be a Single Level Cell (SLC) NAND flash memory module, a Trinary Level Cell (TLC) NAND flash memory module, other flash memory modules or any memory module having the same features.

FIG. 3 is a schematic block diagram illustrating a memory control circuit unit according to an exemplary embodiment.

Referring to FIG. 3, the memory control circuit unit 104 includes a memory management circuit 202, a host interface 204 and a memory interface 206.

The memory management circuit 202 is configured to control overall operations of the memory control circuit unit 104. Specifically, the memory management circuit 202 has a plurality of control commands. When the memory storage device 100 operates, the control commands are executed to perform various operations such as data writing, data reading and data erasing. Operations of the memory management circuit 202 are similar to the operations of the memory control circuit unit 104, thus related description is omitted hereinafter.

In the present exemplary embodiment, the control commands of the memory management circuit 202 are implemented in a form of a firmware. For instance, the memory management circuit 202 has a microprocessor unit (not illustrated) and a ROM (not illustrated), and the control commands are burned into the ROM. When the memory storage device 100 operates, the control commands are executed by the microprocessor to perform operations of writing, reading or erasing data.

In another exemplary embodiment of the invention, the control commands of the memory management circuit 202 may also be stored as program codes in a specific area (for example, the system area in a memory exclusively used for storing system data) of the rewritable non-volatile memory module 106. In addition, the memory management circuit 202 has a microprocessor unit (not illustrated), a ROM (not illustrated) and a RAM (not illustrated). More particularly, the ROM has a boot code, which is executed by the microprocessor unit to load the control commands stored in the rewritable non-volatile memory module 106 to the RAM of the memory management circuit 202 when the memory control circuit unit 104 is enabled. Next, the control commands are executed by the microprocessor unit to perform operations of writing, reading or erasing data.

Further, in another exemplary embodiment of the invention, the control commands of the memory management circuit 202 may also be implemented in a form of hardware. For example, the memory management circuit 220 includes a microcontroller, a memory management unit, a memory writing unit, a memory reading unit, a memory erasing unit and a data processing unit. The memory management unit, the memory writing unit, the memory reading unit, the memory erasing unit and the data processing unit are coupled to the microprocessor. The memory management unit is configured to manage the physical erasing units of the rewritable non-volatile memory module 106; the memory writing unit is configured to issue a write command to the rewritable non-volatile memory module 106 in order to write data to the rewritable non-volatile memory module; the memory reading unit is configured to issue a read command to the rewritable non-volatile memory module 106 in order to read data from the rewritable non-volatile memory module 106; the memory erasing unit is configured to issue an erase command to the rewritable non-volatile memory module 106 in order to erase data from the rewritable non-volatile memory module 106; the data processing unit is configured to process both the data to be written to the rewritable non-volatile memory module 106 and the data to be read from the rewritable non-volatile memory module 106.

The host interface 204 is coupled to the memory management circuit 202 and configured to receive and identify commands and data sent from the host system 1000. Namely, the commands and data sent from the host system 1000 are passed to the memory management circuit 202 through the host interface 204. In the present exemplary embodiment, the host interface 204 is compatible to a SATA standard. However, it should be understood that the present invention is not limited thereto, and the host interface 204 may also be compatible with a PATA standard, an IEEE 1394 standard, a PCI Express standard, a USB standard, a SD standard, a UHS-I standard, a UHS-II standard, a MS standard, a MMC standard, a eMMC standard, a UFS standard, a CF standard, an IDE standard, or other suitable standards for data transmission.

The memory interface 206 is coupled to the memory management circuit 202 and configured to access the rewritable non-volatile memory module 106. That is, data to be written to the rewritable non-volatile memory module 106 is converted to a format acceptable to the rewritable non-volatile memory module 106 through the memory interface 206.

In an exemplary embodiment of the invention, the memory control circuit unit 104 further includes a buffer memory 252, a power management circuit 254 and an error checking and correcting circuit 256.

The buffer memory 252 is coupled to the memory management circuit 202 and configured to temporarily store data and commands from the host system 1000 or data from the rewritable non-volatile memory module 106.

The power management unit 254 is coupled to the memory management circuit 202 and configured to control a power of the memory storage device 100.

The error checking and correcting circuit 256 is coupled to the memory management circuit 202 and configured to perform an error checking and correcting process to ensure the correctness of data. Specifically, when the memory management circuit 202 receives a write command from the host system 1000, the error checking and correcting circuit 256 generates an error correcting code (ECC code) for data corresponding to the write command, and the memory management circuit 202 writes data and the ECC code corresponding to the write command to the rewritable non-volatile memory module 106. Subsequently, when the memory management circuit 202 reads the data from the rewritable non-volatile memory module 106, the ECC code corresponding to the data is also read, and the error checking and correcting circuit 256 may execute the error checking and correcting procedure for the read data according to the ECC code.

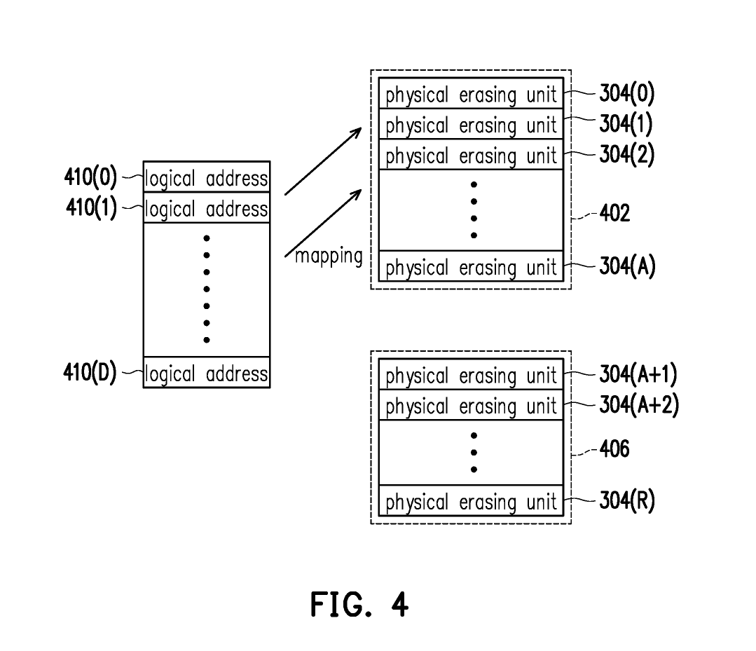

FIG. 4 is a schematic diagram illustrating an example for a management under a memory storage device according to an exemplary embodiment.

It should be understood that terms, such as “select”, “group”, “divide”, “associate” and so forth, are logical concepts which describe operations in the physical erasing units of the rewritable non-volatile memory module 106. That is, the physical erasing units of the rewritable non-volatile memory module are logically operated, but actual positions of the physical units of the rewritable non-volatile memory module are not changed.

Referring to FIG. 4, the memory management circuit 202 may logically divide the physical erasing units 304(0) to 304(R) of the rewritable non-volatile memory module 106 into a plurality of areas such as a storage area 402 and a system area 406.

The physical erasing units in the storage area 402 are configured to store data from the host system 1000. The storage area 402 stores valid data and invalid data. For example, when the host system intends to delete one valid data, the data being deleted may still be stored in the storage area 402 but marked as the invalid data. The physical erasing unit not storing the valid data may also be referred to as a spare physical erasing unit. The physical programming unit not storing the valid data may also be referred to as a spare physical programming unit. For example, the physical erasing unit being erased may become the spare physical erasing unit. In case there are damaged physical erasing units in the storage area 402 or the system area 406, the physical erasing units in the storage area 402 may also be used to replace the damaged physical erasing units. If there are no available physical erase units in the storage area 402 for replacing the damaged physical erasing units, the memory storage device 100 is announced by the memory management circuit 202 as being in a write protect status, and data cannot be written therein.

The physical erasing units in the system area 406 are configured to record system information including information related to manufacturer and model of a memory chip, a number of physical erasing units in the memory chip, a number of the physical programming unit in each physical erasing unit, and so forth.

Amounts of the physical erasing units in the storage area 402 and the system area 406 may be different to each other based on the different memory specifications. In addition, it should be understood that, during operations of the memory storage device 100, grouping relations of the physical erasing units associated to the storage area 402 and the system area 406 may be dynamically changed. For example, when damaged physical erasing units in the system area 406 are replaced by the physical erasing units in the storage area 402, the physical erasing units originally from the storage area 402 are then associated to the system area 406.

The memory management circuit 202 may also be configured with logical addresses 410(0) to 410(D) for mapping to part of the physical erasing units 304(0) to 304(A) in the storage area 402. The host system 1000 may access the data in the storage area 402 through the logical addresses 410(0) to 410(D). In the present exemplary embodiment, one logical address is mapped to one physical sector, a logical programming unit is constituted by multiple logical addresses, and a logical erasing unit is constituted by multiple logical programming units. One logical programming unit is mapped to one or more physical programming units, and one logical erasing unit is mapped to one or more physical erasing units. In the present exemplary embodiment, the memory management circuit 202 uses the logical programming units to manage the corresponding physical erasing unit. Further, the memory management circuit 202 establishes a logical address-physical erasing unit mapping table to record a mapping relation between the logical addresses and the physical erasing units. The logical address-physical erasing unit mapping table may also record, for example, various corresponding relation between logical and physical entities, such as a mapping relation between the logical addresses and the physical programming units, a mapping relation between the logical programming units and the physical programming units and/or a mapping relation between the logical programming units and the physical erasing units, which are not particularly limited by the invention.

The memory management circuit 202 may select one or more physical erasing units from the spare physical erasing units in the storage area 402 to be used (i.e., served) as a receiving physical erasing unit. The memory management circuit 202 may select one or more physical erasing units from the spare physical erasing units in the storage area 402 to be used (i.e., served) as a recycling physical erasing unit. For example, the memory management circuit 202 may number the physical erasing unit currently served as the receiving physical erasing unit (also referred to as a first spare physical erasing unit) and the physical erasing unit currently served as the recycling physical erasing unit (also referred to as a second spare physical erasing unit), and identify the first spare physical erasing unit currently used as the receiving physical erasing unit and the second spare physical erasing unit currently used as the recycling physical erasing unit by way of utilizing a look up table. The physical erasing unit used as the receiving physical erasing unit is only used for writing the data from the host system 100, whereas the physical erasing unit used as the recycling physical erasing unit is only used for writing the valid data from part of the physical erasing units in the storage area 402 in a garbage collection procedure. Further, in an exemplary embodiment, none of the physical erasing units will be used as the receiving physical erasing unit and the recycling physical erasing unit at the same time.

The memory management circuit 202 may receive a first write command from the host system 1000. The first write command instructs to write a first data into at least one first logical address among the logical addresses 410(0) to 410(D). The memory management circuit 202 may write the first data into the receiving physical erasing unit. For example, it is assumed that the physical erasing unit currently used as the receiving physical erasing unit is the first spare physical erasing unit, thus the memory management circuit 202 may write the first data into the first spare physical erasing unit.

The memory management circuit 202 may select one or more physical erasing units (also referred to as first physical erasing unit) from the physical erasing units in the storage area 402. The first physical erasing unit mentioned herein stores a plurality of data in which at least two data belong to different logical erasing units. At a specific time point, the memory management circuit 202 may execute a garbage collection procedure to copy the valid data from the data stored in the first physical erasing unit, and write the copied valid data into the recycling physical erasing unit (e.g., the second spare physical erasing unit). The specific time point as mentioned herein may be, for example, times when a quantity of the spare physical erasing units in the storage area 402 reaches a quantity threshold. The quantity threshold may be, for example, 1, 2 or more. For examples, each time the memory management circuit 202 selects one of the spare physical erasing units from the storage area 402 to be used as the receiving physical erasing unit or the recycling physical erasing unit, the memory management circuit 202 may determine whether the quantity of remaining spare physical erasing units reaches the quantity threshold. Once the quantity of the remaining physical erasing units reaches the quantity threshold, the memory management circuit 202 may then execute the garbage collection procedure. Further, the memory management circuit 202 may also execute the garbage collection procedure after idle for a preset time period (e.g., when none of write commands is received from the host system 1000 within the preset time period) or at any time points. Moreover, the memory management circuit 202 may also execute the garbage collection procedure each time the data is written into the receiving physical erasing unit. In other words, the memory management circuit 202 is capable of executing part of the garbage collection procedure for the first physical erasing unit, and when the physical erasing unit currently used as the receiving physical erasing units is fully written, the memory management circuit 202 may synchronously release at least one spare physical erasing unit, so as to ensure that the spare physical erasing units in the storage area 402 are maintained at a preset amount.

It should be noted that, the physical erasing unit used as the receiving physical erasing unit and the physical erasing unit used as the recycling physical erasing unit are not fixed and independent from each other. For example, while writing the first data into the first spare physical erasing unit, the memory management circuit 202 may determine whether the first spare physical erasing unit is fully written. When the first spare physical erasing unit is fully written, the memory management circuit 202 may select one or more another spare physical erasing units from the spare physical erasing units in the storage area 402 for replacing the first spare physical erasing unit being fully written as the new receiving physical erasing unit, and then the entire or part of the first data (not being written completely into the first spare physical erasing unit) is written into the newly selected spare physical erasing unit which is currently served as the receiving physical erasing unit. Similarly, while writing the copied valid data into the second spare physical erasing unit, the memory management circuit 202 may determine whether the second spare physical erasing unit is fully written. When the second spare physical erasing unit is fully written, the memory management circuit 202 may select one or more another spare physical erasing units from the spare physical erasing units in the storage area 402 for replacing the second spare physical erasing unit being fully written as the new recycling physical erasing unit, and then the entire or part of the valid data (not being written completely into the second spare physical erasing unit) is written into the newly selected spare physical erasing unit which is currently served as the recycling physical erasing unit.

It should be noted that, the first physical erasing unit does not include the physical erasing unit currently used as the receiving physical erasing unit and the physical erasing unit currently used as the recycling physical erasing unit. For example, in case the physical erasing unit used as the receiving physical erasing unit is the first spare physical erasing unit, then the first physical erasing unit does not include the first spare physical erasing unit. In case the physical erasing unit used as the recycling physical erasing unit is the second spare physical erasing unit, then the first physical erasing unit does not include the second spare physical erasing unit. In other words, if a specific physical erasing unit is currently used as the receiving physical erasing unit or the physical erasing unit, then the specific physical erasing unit is not selected to be used as the first physical erasing unit for copying valid data therefrom. Similarly, if a specific physical erasing unit is currently used as the receiving physical erasing unit, then the specific physical erasing unit is not selected to be used as the recycling physical erasing unit at the same time; if a specific physical erasing unit is currently used as the recycling physical erasing unit, then the specific physical erasing unit is not selected to be used as the receiving physical erasing unit at the same time.

In an exemplary embodiment, the valid data copied from the first physical erasing unit at least includes a first valid data and a second valid data, and the logical erasing unit (also known as a first logical erasing unit) to which the first valid data belongs is different from the logical erasing unit (also known as a second logical erasing unit) to which the second valid data belongs. In other words, for the host system 1000, the first valid data is stored in the first logical erasing unit to which one or more first logical addresses belongs, and the second valid data is stored in the second logical erasing unit to which one or more second logical addresses belongs. Further, aforesaid operation of writing the copied valid data into the recycling physical erasing unit may also be considered as moving of the valid data by the memory management circuit 202. After writing the copied valid data into the recycling physical erasing unit, the memory management circuit 202 may erase the first physical erasing unit. The erased first physical erasing unit may then be considered as the spare physical erasing unit.

In the present exemplary embodiment, the memory management circuit 202 considers all of the physical erasing units in the storage area 402 as the first physical erasing unit, except the physical erasing unit currently used as the receiving physical erasing unit and the physical erasing unit currently used as the recycling physical erasing unit. However, in another exemplary embodiment, the memory management circuit 202 only considers one or more physical erasing units which satisfy a specific condition among the physical erasing units as the first physical erasing unit. For example, the specific condition may be related to an amount and/or a written time of the valid data stored in each physical erasing unit in the storage area 402. In the present exemplary embodiment, expect the physical erasing unit currently used as the receiving physical erasing unit and the physical erasing unit currently used as the recycling physical erasing unit, the memory management circuit 202 may consider one or more physical erasing units stored with the valid data having a least amount and/or an earliest written time among all the physical erasing units in the storage area 402 as the first physical erasing unit. Further, in other exemplary embodiments, the memory management circuit 202 may also select the first physical erasing unit according to any conditions (e.g., based on whether a proportion between the valid data and the invalid data in the physical erasing unit matches a preset proportion), but the invention is not limited thereto.

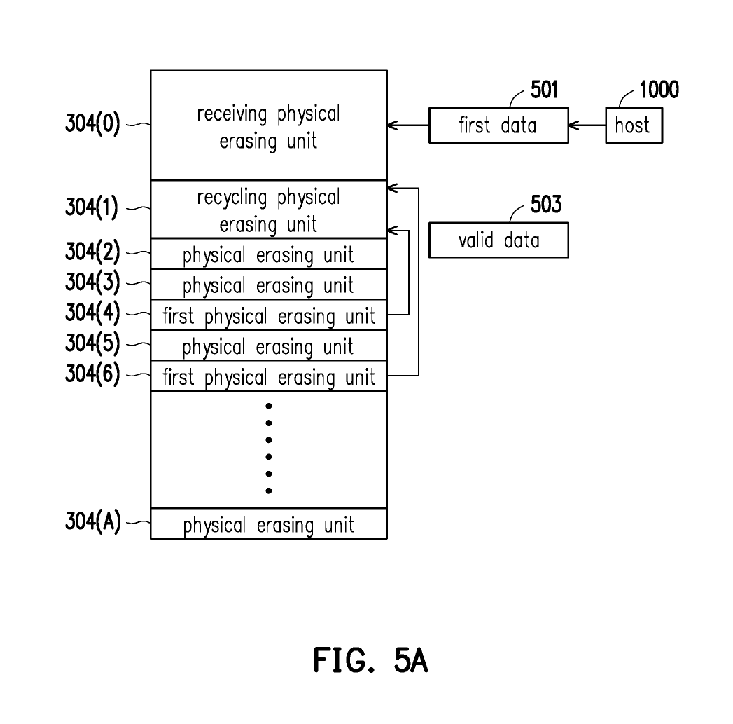

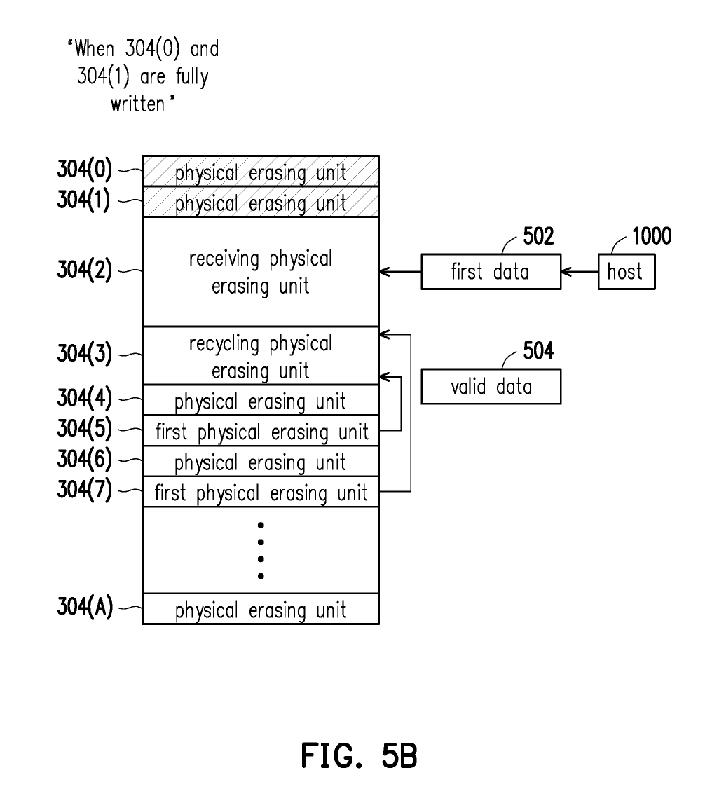

FIG. 5A and FIG. 5B are schematic diagrams illustrating management of a memory storage device according to an exemplary embodiment.

Referring to FIG. 5A, it is assumed that the physical erasing unit 304(0) is currently used as the receiving physical erasing unit and the physical erasing unit 304(1) is currently used as the recycling physical erasing unit. When the memory management circuit 202 receives a write command, the memory management circuit 202 may write a data 501 (also referred to as first data) indicated by the write command into the physical erasing unit 304(0) currently served as the receiving physical erasing unit. Assuming that the memory management circuit 202 selects the physical erasing units 304(4) and 304(6) to be the first physical erasing units, the memory management circuit 202 may execute the garbage collection procedure for the physical erasing units 304(4) and 304(6) at the specific time point, so as to copy the valid data 503 from the physical erasing units 304(4) and 304(6) to the physical erasing unit 304(1) currently served as the recycling physical erasing unit, as shown in FIG. 5A. After all the valid data 503 in the physical erasing units 304(4) and 304(6) are copied to the physical erasing unit 304(1), the memory management circuit 202 may erase the physical erasing units 304(4) and 304(6) to make the physical erasing units 304(4) and 304(6) become the spare physical erasing units.

Referring to FIG. 5B, after the physical erasing unit 304(0) and the physical erasing unit 304(1) are fully written, it is assumed that the memory management circuit 202 selects the physical erasing unit 304(2) to be used as the receiving physical erasing unit and selects the physical erasing unit 304(3) to be used as the recycling physical erasing unit. Namely, the physical erasing unit currently served as the receiving physical erasing unit is changed from the physical erasing unit 304(0), which is fully written, to the physical erasing unit 304(2), and the physical erasing unit currently served as the recycling physical erasing unit is changed from the physical erasing unit 304(1), which is fully written, to the physical erasing unit 304(3). When the memory management circuit 202 receives another write command, the memory management circuit 202 may write a data 502 indicated by said another write command into the physical erasing unit 304(2) currently served as the receiving physical erasing unit. Assuming that the memory management circuit 202 selects the physical erasing units 304(5) and 304(7) to be the first physical erasing units, the memory management circuit 202 may execute the garbage collection procedure for the physical erasing units 304(5) and 304(7) at the specific time point, so as to copy the valid data 504 from the physical erasing units 304(5) and 304(7) to the physical erasing unit 304(3) currently served as the recycling physical erasing unit, as shown in FIG. 5B. After all the valid data 504 in the physical erasing units 304(5) and 304(7) are copied to the physical erasing unit 304(3), the memory management circuit 202 may erase the physical erasing units 304(5) and 304(7) to make the physical erasing units 304(5) and 304(7) become the spare physical erasing units.

In other words, any data that is from the host system 1000 and intended to be written into the rewritable non-volatile memory module 106 is firstly written into the receiving physical erasing unit, and any data that is collected due to the garbage collection procedure is written into the recycling physical erasing unit, thus the old valid data of the rewritable non-volatile memory module 106 and the new data from the host system 1000 will not be written into the same physical erasing unit. In addition, the spare physical erasing unit is also continuously released with execution of the garbage collection procedure, a writing speed of the memory management circuit 202 for the rewritable non-volatile memory module 106 will not be decreased owing to the cross storage of the new and old data in the same physical erasing unit and/or insufficient spare physical erasing unit, even after the rewritable non-volatile memory module 106 has been used for a long period of time.

In an exemplary embodiment, as in response to the memory management circuit 202 writing the valid data from the first physical erasing unit into the recycling physical erasing unit, the memory management circuit 202 may also record a moving information of the valid data written into the recycling physical erasing unit. However, temporarily, the memory management circuit 202 does not update the logical address-physical erasing unit mapping table according to the valid data written into the recycling physical erasing unit. The reason is that, while the memory management circuit 202 is writing the valid data into the recycling physical erasing unit, it is possible that other data belonging to the same logical programming unit to which the valid data belongs may be written into the receiving physical erasing unit at the same time. Under such circumstance, the data originally considered as the valid data and moved to the recycling physical erasing unit may become the invalid data. Therefore, if a mapping relation between the logical address of the valid data and the recycling physical erasing unit is already updated to the logical address-physical erasing unit mapping table, such mapping relation may become invalid accordingly.

In this exemplary embodiment, it is assumed that the memory management circuit 202 receives a second write command while the memory management circuit 202 is moving the valid data to the recycling physical erasing unit or at any time points. The second write command instructs to write a second data into at least one second logical address among the logical addresses 410(0) to 410(D). The memory management circuit 202 may write the second data into the receiving physical erasing unit. The memory management circuit 202 may determine whether the logical programming unit (also known as a first logical programming unit) to which any one of the at least one valid data written into the recycling physical erasing unit belongs is identical to the logical programming unit (also known as a second logical programming unit) to which the second data belongs. The memory management circuit 202 updates the logical address-physical erasing unit mapping table according to the moving information only when the first logical programming unit and the second logical programming unit are not identical. Otherwise, when the first logical programming unit and the second logical programming unit are identical, the memory management circuit 202 may mark the valid data written into the recycling physical erasing unit as the invalid data.

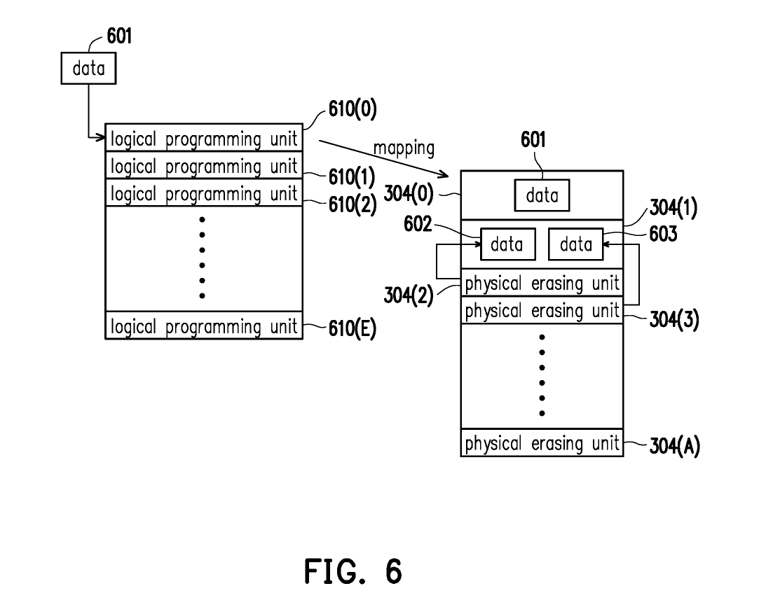

FIG. 6 is a schematic diagram illustrating management of a rewritable non-volatile memory module according to an exemplary embodiment of the invention.

Referring to FIG. 6, it is assumed that the physical erasing unit 304(0) is currently used as the receiving physical erasing unit, and the physical erasing unit 304(1) is currently used as the recycling physical erasing unit. In this case, when the memory management circuit 202 receives a write command which instructs to write a data 601 into the logical address belonging to the logical programming unit 610(0), the memory management circuit 202 may write the data 601 into the logical programming unit 610(0), map the logical programming unit 610(0) to the physical erasing unit 304(0), and write the data 601 into the physical erasing unit 304(0). Assuming that the memory management circuit 202 selects the physical erasing units 304(2) and 304(3) to be the first physical erasing unit, the memory management circuit 202 may execute the garbage collection procedure for the physical erasing units 304(2) and 304(3) at the specific time point, so as to write the valid data (i.e., data 602 and 603) from the physical erasing units 304(2) and 304(3) into the physical erasing unit 304(1) which is currently served as the recycling physical erasing unit, and record the moving information of the data 602 and 603 being written into the physical erasing unit 304(1). After the data 602 and 603 are written into the physical erasing unit 304(1), the memory management circuit 202 may determine whether the logical programming unit 610(0) to which the data 601 belongs is identical to the logical programming unit to which any one of the data 602 and 603 belongs. In case the logical programming unit 610(0) to which the data 601 belongs is not identical to the logical programming unit to which any one of the data 602 and the data 603 belongs (e.g., the logical programming unit to which the data 602 belongs is the logical programming unit 610(1) and the logical programming unit to which the data 603 belongs is the logical programming unit 610(2)), the memory management circuit 202 may update the mapping relation between the logical programming unit 610(1) to which the data 602 belongs and the physical erasing unit 304(1) and the mapping relation between the logical programming unit 610(2) to which the data 603 belongs and the physical erasing unit 304(1) to the logical address-physical erasing unit mapping table according to the moving information of the data 602 and the data 603 previously recorded. On the contrary, in case the logical programming unit 610(0) to which the data 601 is identical to the logical programming unit to which any one of the data 602 and the data 603 belongs (e.g., the logical programming unit to which the data 602 belongs is also the logical programming unit 610(0)), the memory management circuit 202 may mark the data 602 as invalid, and only update the mapping relation between the logical programming unit to which the data 603 belongs and the physical erasing unit 304(1) to the logical address-physical erasing unit mapping table, so as to improve a updating efficiency of the logical address-physical erasing unit mapping table.

Further, in another exemplary embodiment of FIG. 6, the memory management circuit 202 may pre-determine whether the logical programming unit 610(0) to which the data 601 belongs is identical to the logical programming unit to which the data 602 or the data 603 belongs before or while writing the data 602 and 603 into the physical erasing unit 304(1). In case the logical programming unit 610(0) to which the data 601 belongs is identical to the logical programming unit to which any one of the data 602 and the data 603 belongs, the memory management circuit 202 stops the operation of writing or moving the data 602 and/or 603 into the physical erasing unit 304(1). For example, assuming that a write command that instructs to write the data 601 into the logical programming unit 610(0) is received, the memory management circuit 202 is then informed that the garbage collection procedure for the physical erasing units 304(2) and 304(3) is about to be executed. In this case, the memory management circuit 202 may determine whether the logical programming unit 610(0) to which the data 601 belongs is identical to the logical programming unit to which the data 602 or the data 603 belongs. For example, assuming that the logical programming unit to which the data 602 belongs is also the logical programming unit 610(0), the memory management circuit 202 may then mark the data 602 from the valid data to the invalid data, and stop the operations of copying and writing the data 602, so as to reduce chances for the physical erasing unit 304(1) to be written with the invalid data. On the contrary, if the logical programming unit 610(0) to which the data 601 belongs is not identical to the logical programming unit to which any one of the data 602 and the data 603 belongs, the memory management circuit 202 will not stop the operations of copying and writing the data 602 and the data 603.

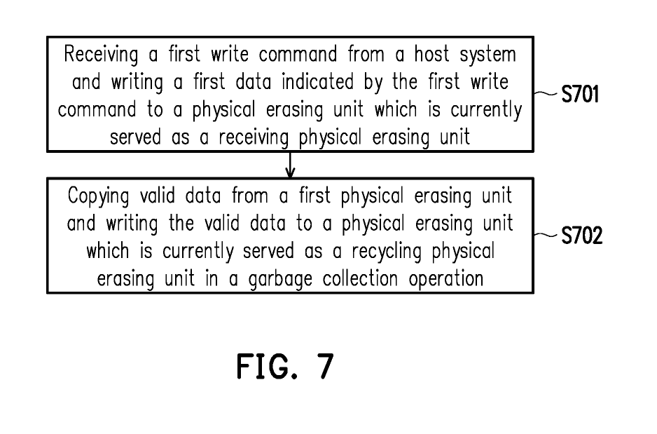

FIG. 7 is a flowchart illustrating a memory management method according to an exemplary embodiment of the invention.

Referring to FIG. 7, in step S701, a first write command is received from a host system and first data indicated by the first write command is written to a physical erasing unit which is currently served as a receiving physical erasing unit. In step S702, valid data is copied from a first physical erasing unit and the valid data is written to a physical erasing unit which is currently served as a recycling physical erasing unit in a garbage collection operation. It is noted that, the physical erasing unit currently served as the receiving physical erasing unit and the physical erasing unit currently served as the recycling physical erasing unit are two physical erasing units independent from each other. For example, in an exemplary embodiment of FIG. 5A, the physical erasing unit currently served as the receiving physical erasing unit is the physical erasing unit 304(0), the physical erasing unit currently served as the recycling physical erasing unit is the physical erasing unit 304(1), and the first physical erasing units from which the valid data is copied are the physical erasing units 304(4) and 304(6). Alternatively, in an exemplary embodiment of FIG. 5B, the physical erasing unit currently served as the receiving physical erasing unit is the physical erasing unit 304(2), the physical erasing unit currently served as the recycling physical erasing unit is the physical erasing unit 304(3), and the first physical erasing units from which the valid data is copied are the physical erasing units 304(5) and 304(7).

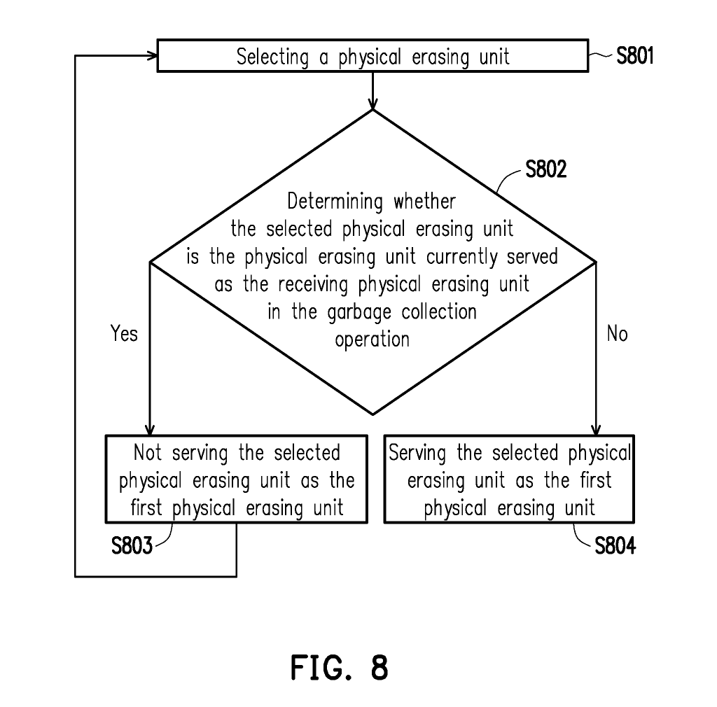

FIG. 8 is a flowchart illustrating a memory management method according to an exemplary embodiment of the invention.

Referring to FIG. 8, in step S801, in the garbage collection operation, a physical erasing unit is selected, in order to determine the first physical erasing unit. In step S802, it is determined whether the selected physical erasing unit is the physical erasing unit currently served as the receiving physical erasing unit in the garbage collection operation. If the selected physical erasing unit is the physical erasing unit currently served as the receiving physical erasing unit, in step S803, the selected physical erasing unit is not served as the first physical erasing unit, and step S801 is repeated to select another physical erasing unit.

If the selected physical erasing unit is not the physical erasing unit currently served as the receiving physical erasing unit, in step S804, the selected physical erasing unit may be served as the first physical erasing unit. Taking FIG. 5A as an example, if the physical erasing unit 304(0) which is currently served as the receiving physical erasing unit is selected in step S801, the physical erasing unit 304(0) is not determined to be the first physical erasing unit and the valid data is not copied from the physical erasing unit 304(0). Alternatively, if the physical erasing unit 304(4) which is not currently served as the receiving physical erasing unit is selected in step S801, the physical erasing unit 304(4) could be determined to be the first physical erasing unit and the valid data could be copied from the physical erasing unit 304(4).

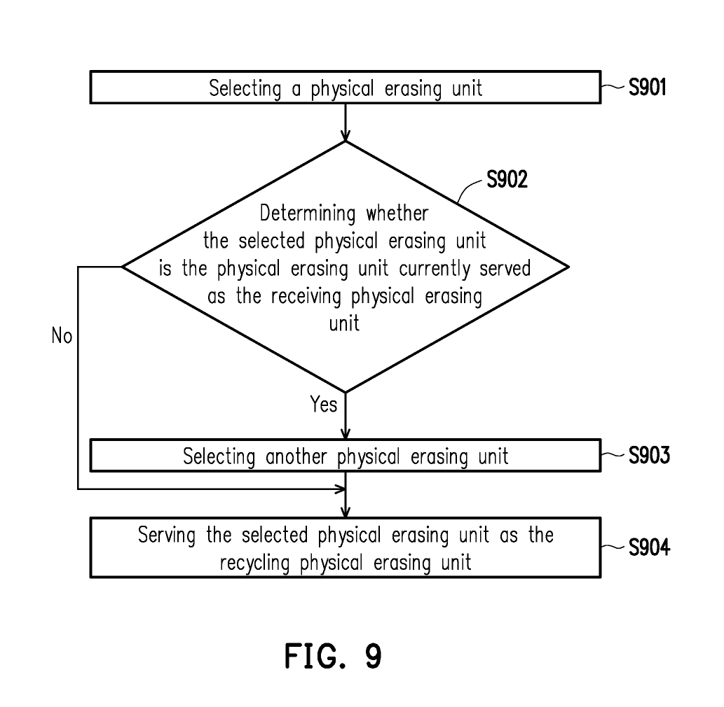

FIG. 9 is a flowchart illustrating a memory management method according to an exemplary embodiment of the invention.

Referring to FIG. 9, in step S901, in the garbage collection operation, a physical erasing unit is selected, in order to determine the recycling physical erasing unit. In step S902, it is determined whether the selected physical erasing unit is the physical erasing unit currently served as the receiving physical erasing unit. If the selected physical erasing unit is the physical erasing unit currently served as the receiving physical erasing unit, in step S903, another physical erasing unit which is not the physical erasing unit currently served as the receiving physical erasing unit is selected. In step 904, the selected another physical erasing unit may be served as the recycling physical erasing unit. Alternatively, in step S902, if it is determined that the selected physical erasing unit is not the physical erasing unit currently served as the receiving physical erasing unit, then the selected physical erasing unit may be served as the recycling physical erasing unit in step S904.

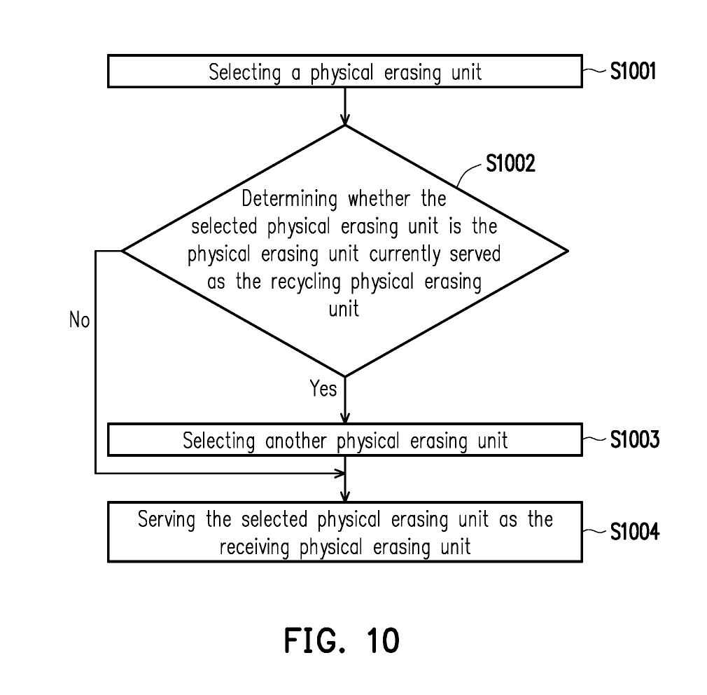

FIG. 10 is a flowchart illustrating a memory management method according to an exemplary embodiment of the invention.

Referring to FIG. 10, in step S1001, in the garbage collection operation, a physical erasing unit is selected, in order to determine the receiving physical erasing unit. In step S1002, it is determined whether the selected physical erasing unit is the physical erasing unit currently served as the recycling physical erasing unit. If the selected physical erasing unit is the physical erasing unit currently served as the recycling physical erasing unit, in step S1003, another physical erasing unit which is not the physical erasing unit currently served as the recycling physical erasing unit is selected. In step 1004, the selected another physical erasing unit may be served as the receiving physical erasing unit. Alternatively, in step S1002, if it is determined that the selected physical erasing unit is not the physical erasing unit currently served as the recycling physical erasing unit, then the selected physical erasing unit may be served as the receiving physical erasing unit in step S1004.

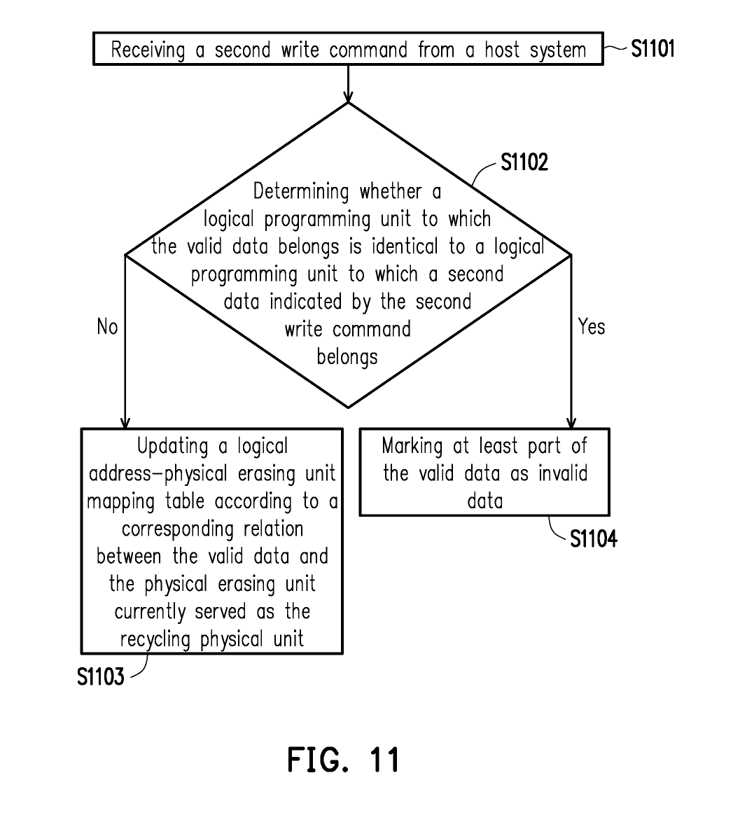

FIG. 11 is a flowchart illustrating a memory management method for updating a logical address-physical erasing unit mapping table according to an embodiment of the invention.

In step S1101, a write command (e.g. the second write command) is received after another write command (e.g., the first write command), wherein the second write command instructs to write a second data into at least one second logical address among the logical addresses. In step S1102, it is determined whether a logical programming unit to which the second data belongs is identical to the logical programming unit to which the copied valid data belongs. In step S1103, if it is determined that the logical programming unit to which the second data belongs is not identical to the logical programming unit to which the valid data belongs, a logical address-physical erasing unit mapping table is updated according to a corresponding relation between the valid data and the physical erasing unit currently served as the recycling physical erasing unit. In step S1104, if it is determined that the logical programming unit to which the second data belongs is identical to the logical programming unit to which the valid data belongs, at least part of the valid data is marks as invalid data. Detailed description of FIG. 11 may be obtained with reference to the exemplary embodiment of FIG. 6.

Nevertheless, steps depicted in FIG. 7 to FIG. 11 are described in detail as above, thus related description is omitted hereinafter. It should be noted that, the steps depicted in FIG. 7 to FIG. 11 may be implemented as a plurality of program codes or circuits. For example, the steps depicted in FIG. 7 to FIG. 11 may be performed by the memory management circuit 202 of FIG. 3. Also, a sequence for executing the steps depicted in FIG. 7 to FIG. 11 respectively may be adjusted according to practical demands, and the invention is not limited thereto. The method disclosed in FIG. FIG. 7 to FIG. 11 may be implemented with reference to the foregoing embodiments or may be implemented separately, and the invention is not limited thereto.

In addition, control commands of the memory management circuit 202 corresponding to the operations of “select”, “write”, “move”, “read”, “garbage collection” and “erase” for the rewritable non-volatile memory module 106 may be implemented as various command sequences each may include one or more commands (e.g., command codes). For example, in case the memory management circuit 202 is executing a select operation to the rewritable non-volatile memory module 106, the memory management circuit 202 may send a command sequence in which the command sequence is configured to instruct to select one or more physical erasing units from the physical erasing units of the storage area 402. The rest of operating instructions may be deduced by analogy. The rewritable non-volatile memory module 106 may execute the operations corresponding to the command sequences issued by the memory management circuit 202.

In summary, the memory management method, the memory storage device and the memory control circuit unit of the invention are capable of writing the data from the host system into the receiving physical erasing unit, and writing the valid data collected from part of physical erasing units in the rewritable non-volatile memory module into the recycling physical erasing unit. Accordingly, the new data and the old valid data in the rewritable non-volatile memory module will not be stored in the same physical erasing unit, so as to effectively solve the problem in which the data writing efficiency of the rewritable non-volatile memory module is lowered after being used for a long period of time. In particular, the problem of the writing efficiency in the sequential write being lowered due to the new and old data being stored together may be effectively solved.

The previously described exemplary embodiments of the present invention have the advantages aforementioned, wherein the advantages aforementioned not required in all versions of the invention.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A memory management method, for a rewritable non-volatile memory module having a plurality of physical erasing units, and the memory management method comprising:
receiving a first write command from a host system and writing a first data indicated by the first write command to a physical erasing unit which is currently served as a receiving physical erasing unit among the physical erasing units; and
copying valid data from a first physical erasing unit among the physical erasing units and writing the valid data to a physical erasing unit which is currently served as a recycling physical erasing unit among the physical erasing units in a garbage collection operation,
wherein the physical erasing unit currently served as the receiving physical erasing unit and the physical erasing unit currently served as the recycling physical erasing unit are two physical erasing units independent from each other.

2. The memory management method of claim 1, further comprising:
selecting a physical erasing unit from the physical erasing units;
determining whether the selected physical erasing unit is the physical erasing unit currently served as the receiving physical erasing unit in the garbage collection operation; and
if the selected physical erasing unit is the physical erasing unit currently served as the receiving physical erasing unit, not serving the selected physical erasing unit as the first physical erasing unit.

3. The memory management method of claim 2, further comprising:
if the selected physical erasing unit is the physical erasing unit currently served as the receiving physical erasing unit, selecting another physical erasing unit from the physical erasing units;
determining whether the selected another physical erasing unit is the physical erasing unit currently served as the receiving physical erasing unit in the garbage collection operation; and
if the selected another physical erasing unit is not the physical erasing unit currently served as the receiving physical erasing unit, serving the selected another physical erasing unit as the first physical erasing unit.

4. The memory management method of claim 1, further comprising:
selecting a physical erasing unit from the physical erasing units;
determining whether the selected physical erasing unit is the physical erasing unit currently served as the receiving physical erasing unit; and
if the selected physical erasing unit is the physical erasing unit currently served as the receiving physical erasing unit, selecting another physical erasing unit from the physical erasing units and serving the selected another physical erasing unit as the recycling physical erasing unit.

5. The memory management method of claim 1, further comprising:
selecting a physical erasing unit from the physical erasing units;
determining whether the selected physical erasing unit is the physical erasing unit currently served as the recycling physical erasing unit; and
if the selected physical erasing unit is the physical erasing unit currently served as the recycling physical erasing unit, selecting another physical erasing unit from the physical erasing units and serving the selected another physical erasing unit as the receiving physical erasing unit.

6. The memory management method of claim 1, wherein the physical erasing unit currently served as the receiving physical erasing unit is only configured to store data from the host system, and the physical erasing unit currently served as the recycling physical erasing unit is only configured to store the valid data copied from the first physical erasing unit in the garbage collection operation.

7. The memory management method of claim 1, further comprising:
performing the garbage collection operation if a quantity of at least one spare physical erasing unit among the physical erasing units reaches a quantity threshold.

8. The memory management method of claim 1, further comprising:
receiving a second write command from the host system;
determining whether a logical programming unit to which the valid data belongs is identical to a logical programming unit to which a second data indicated by the second write command belongs;
if the logical programming unit to which the valid data belongs is not identical to the logical programming unit to which the second data belongs, updating a logical address-physical erasing unit mapping table according to a corresponding relation between the valid data and the physical erasing unit currently served as the recycling physical unit; and
if the logical programming unit to which the valid data belongs is identical to the logical programming unit to which the second data belongs, marking at least part of the valid data as invalid data.

9. The memory management method of claim 1, further comprising:
selecting a physical erasing unit from the physical erasing units;
determining whether the selected physical erasing unit is not the physical erasing unit currently served as the receiving physical erasing unit; and
serving the selected physical erasing unit as the first physical erasing unit.

10. A memory storage device, comprising:
a connection interface unit configured to couple to a host system;
a rewritable non-volatile memory module comprising a plurality of physical erasing units; and
a memory control circuit unit coupled to the connection interface unit and the rewritable non-volatile memory module,
wherein the memory control circuit unit is configured to receive a first write command from the host system and issue a first write command sequence instructing to write a first data indicated by the first write command to a physical erasing unit which is currently served as a receiving physical erasing unit among the physical erasing units,
wherein the memory control circuit unit is further configured to copy valid data from a first physical erasing unit among the physical erasing units and issue a second write command sequence instructing to writing the valid data to a physical erasing unit which is currently served as a recycling physical erasing unit among the physical erasing units in a garbage collection operation,
wherein the physical erasing unit currently served as the receiving physical erasing unit and the physical erasing unit currently served as the recycling physical erasing unit are two physical erasing units independent from each other.

11. The memory storage device of claim 10, wherein the memory control circuit unit is further configured to select a physical erasing unit from the physical erasing units,
wherein the memory control circuit unit is further configured to determine whether the selected physical erasing unit is the physical erasing unit currently served as the receiving physical erasing unit in the garbage collection operation,
wherein the memory control circuit unit is further configured not to serve the selected physical erasing unit as the first physical erasing unit if the selected physical erasing unit is the physical erasing unit currently served as the receiving physical erasing unit.

12. The memory storage device of claim 11, wherein the memory control circuit unit is further configured to select another physical erasing unit from the physical erasing units if the selected physical erasing unit is the physical erasing unit currently served as the receiving physical erasing unit,
wherein the memory control circuit unit is further configured to determine whether the selected another physical erasing unit is the physical erasing unit currently served as the receiving physical erasing unit in the garbage collection operation,
wherein the memory control circuit unit is further configured to serve the selected another physical erasing unit as the first physical erasing unit if the selected another physical erasing unit is not the physical erasing unit currently served as the receiving physical erasing unit.

13. The memory storage device of claim 10, wherein the memory control circuit unit is further configured to select a physical erasing unit from the physical erasing units,
wherein the memory control circuit unit is further configured to determine whether the selected physical erasing unit is the physical erasing unit currently served as the receiving physical erasing unit,
wherein the memory control circuit unit is further configured to select another physical erasing unit from the physical erasing units and serve the selected another physical erasing unit as the recycling physical erasing unit if the selected physical erasing unit is the physical erasing unit currently served as the receiving physical erasing unit.

14. The memory storage device of claim 10, wherein the memory control circuit unit is further configured to select a physical erasing unit from the physical erasing units,
wherein the memory control circuit unit is further configured to determine whether the selected physical erasing unit is the physical erasing unit currently served as the recycling physical erasing unit,
wherein the memory control circuit unit is further configured to select another physical erasing unit from the physical erasing units and serve the selected another physical erasing unit as the receiving physical erasing unit if the selected physical erasing unit is the physical erasing unit currently served as the recycling physical erasing unit.

15. The memory storage device of claim 10, wherein the physical erasing unit currently served as the receiving physical erasing unit is only configured to store data from the host system, and the physical erasing unit currently served as the recycling physical erasing unit is only configured to store the valid data copied from the first physical erasing unit in the garbage collection operation.

16. The memory storage device of claim 10, wherein the memory control circuit unit is further configured to perform the garbage collection operation if a quantity of at least one spare physical erasing unit among the physical erasing units reaches a quantity threshold.

17. The memory storage device of claim 10, wherein the memory control circuit unit is further configured to receive a second write command from the host system;
wherein the memory control circuit unit is further configured to determine whether a logical programming unit to which the valid data belongs is identical to a logical programming unit to which a second data indicated by the second write command belongs,
wherein the memory control circuit unit is further configured to update a logical address-physical erasing unit mapping table according to a corresponding relation between the valid data and the physical erasing unit currently served as the recycling physical unit if the logical programming unit to which the valid data belongs is not identical to the logical programming unit to which the second data belongs,
wherein the memory control circuit unit is further configured to mark at least part of the valid data as invalid data if the logical programming unit to which the valid data belongs is identical to the logical programming unit to which the second data belongs.

18. The memory storage device of claim 10, wherein the memory control circuit unit is further configured to select a physical erasing unit from the physical erasing units,
wherein the memory control circuit unit is further configured to determine whether the selected physical erasing unit is not the physical erasing unit currently served as the receiving physical erasing unit,
wherein the memory control circuit unit is further configured to serve the selected physical erasing unit as the first physical erasing unit.

19. A memory control circuit unit, configured to control a rewritable non-volatile memory module, wherein the rewritable non-volatile memory module comprises a plurality of physical erasing units, and the memory control circuit unit comprises:
a host interface configured to couple to a host system;
a memory interface configured to couple to the rewritable non-volatile memory module; and
a memory management circuit coupled to the host interface and the memory interface,
wherein the memory management circuit is configured to receive a first write command from the host system and issue a first write command sequence instructing to write a first data indicated by the first write command to a physical erasing unit which is currently served as a receiving physical erasing unit among the physical erasing units,
wherein the memory management circuit is further configured to copy valid data from a first physical erasing unit among the physical erasing units and issue a second write command sequence instructing to writing the valid data to a physical erasing unit which is currently served as a recycling physical erasing unit among the physical erasing units in a garbage collection operation,
wherein the physical erasing unit currently served as the receiving physical erasing unit and the physical erasing unit currently served as the recycling physical erasing unit are two physical erasing units independent from each other.

20. The memory control circuit unit of claim 19, wherein the memory management circuit is further configured to select a physical erasing unit from the physical erasing units,
wherein the memory management circuit is further configured to determine whether the selected physical erasing unit is the physical erasing unit currently served as the receiving physical erasing unit in the garbage collection operation,
wherein the memory management circuit is further configured not to serve the selected physical erasing unit as the first physical erasing unit if the selected physical erasing unit is the physical erasing unit currently served as the receiving physical erasing unit.

21. The memory control circuit unit of claim 20, wherein the memory management circuit is further configured to select another physical erasing unit from the physical erasing units if the selected physical erasing unit is the physical erasing unit currently served as the receiving physical erasing unit,
wherein the memory management circuit is further configured to determine whether the selected another physical erasing unit is the physical erasing unit currently served as the receiving physical erasing unit in the garbage collection operation,
wherein the memory management circuit is further configured to serve the selected another physical erasing unit as the first physical erasing unit if the selected another physical erasing unit is not the physical erasing unit currently served as the receiving physical erasing unit.

22. The memory control circuit unit of claim 19, wherein the memory management circuit is further configured to select a physical erasing unit from the physical erasing units,
wherein the memory management circuit is further configured to determine whether the selected physical erasing unit is the physical erasing unit currently served as the receiving physical erasing unit,
wherein the memory management circuit is further configured to select another physical erasing unit from the physical erasing units and serve the selected another physical erasing unit as the recycling physical erasing unit if the selected physical erasing unit is the physical erasing unit currently served as the receiving physical erasing unit.

23. The memory control circuit unit of claim 19, wherein the memory management circuit is further configured to select a physical erasing unit from the physical erasing units,
wherein the memory management circuit is further configured to determine whether the selected physical erasing unit is the physical erasing unit currently served as the recycling physical erasing unit,
wherein the memory management circuit is further configured to select another physical erasing unit from the physical erasing units and serve the selected another physical erasing unit as the receiving physical erasing unit if the selected physical erasing unit is the physical erasing unit currently served as the recycling physical erasing unit.

24. The memory control circuit unit of claim 19, wherein the physical erasing unit currently served as the receiving physical erasing unit is only configured to store data from the host system, and the physical erasing unit currently served as the recycling physical erasing unit is only configured to store the valid data copied from the first physical erasing unit in the garbage collection operation.

25. The memory control circuit unit of claim 19, wherein the memory management circuit is further configured to perform the garbage collection operation if a quantity of at least one spare physical erasing unit among the physical erasing units reaches a quantity threshold.

26. The memory control circuit unit of claim 19, wherein the memory management circuit is further configured to receive a second write command from the host system;
wherein the memory management circuit is further configured to determine whether a logical programming unit to which the valid data belongs is identical to a logical programming unit to which a second data indicated by the second write command belongs,
wherein the memory management circuit is further configured to update a logical address-physical erasing unit mapping table according to a corresponding relation between the valid data and the physical erasing unit currently served as the recycling physical unit if the logical programming unit to which the valid data belongs is not identical to the logical programming unit to which the second data belongs,
wherein the memory management circuit is further configured to mark at least part of the valid data as invalid data if the logical programming unit to which the valid data belongs is identical to the logical programming unit to which the second data belongs.

27. The memory control circuit unit of claim 19, wherein the memory management circuit is further configured to select a physical erasing unit from the physical erasing units,
wherein the memory management circuit is further configured to determine whether the selected physical erasing unit is not the physical erasing unit currently served as the receiving physical erasing unit,
wherein the memory management circuit is further configured to serve the selected physical erasing unit as the first physical erasing unit.
